(19) United States
(12) Patent Application Publication
(10) Pub. No.: US 2026/0238796 A1
(43) Pub. Date: Aug. 13, 2026

(54) REFINEMENT FOR MERGE MODE MOTION VECTOR DIFFERENCE

(71) Applicant: MEDIATEK INC., Hsinchu City (TW)

(72) Inventors: Shih-Chun Chiu, Hsinchu City (TW); Chen-Yen LAI, Hsinchu City (TW); Guan-Hao CHEN, Hsinchu City (TW); Wen-Chun LIN, Hsinchu City (TW); Tzu-Der CHUANG, Hsinchu City (TW); Ching-Yeh CHEN, Hsinchu City (TW); Chih-Wei HSU, Hsinchu City (TW); Yi-Wen CHEN, San Jose, CA (US)

(21) Appl. No.: 19/471,785

(22) PCT Filed: Apr. 2, 2024
(86) PCT No.: PCT/CN2024/085530

§ 371 Date: Oct. 2, 2025

Related U.S. Application Data
(60) Provisional application No. 63/497,752, filed on Apr. 24, 2023.
(60) Provisional application No. 63/581,706, filed on Sep. 11, 2023.

(51) Int. Cl. H04N 19/139; H04N 19/176; H04N 19/52

(52) U.S. Cl. CPC H04N 19/139; H04N 19/176; H04N 19/52

(57) ABSTRACT

A method for refining merge mode motion vector difference (MMVD) prediction is provided. A video coder receives data to be encoded or decoded as a current block of pixels in a current picture of a video. The video coder encoder selects a merge candidate from a plurality of merge candidates to obtain a base motion for the current block. The video coder refines the base motion by performing bilateral matching. The video coder refines each motion candidate by one or more refinement passes. The video coder generates a prediction of the current block by selecting a refined motion candidate. The refined motion candidates may be assigned indices for selection according to costs that are determined by template matching. The video coder encodes or decodes the current block by using the generated prediction.

### CROSS REFERENCE TO RELATED PATENT APPLICATION(S)

The present disclosure is part of a non-provisional application that claims the priority benefit of U.S. Provisional Patent Application Nos. 63/497,752 and 63/581,706, filed on 24 Apr. 2023 and 11 Sep. 2023, respectively. Contents of above-listed applications are herein incorporated by reference.

### TECHNICAL FIELD

The present disclosure relates generally to video coding. In particular, the present disclosure relates to methods of applying refinement to Merge Mode with Motion Vector Difference (MMVD), including Template Matching (TM), and Multi-Pass Decoder-Side Motion Vector Refinement (MP-DMVR).

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quadtree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide methods for refining merge mode motion vector difference (MMVD) prediction. A video coder receives data to be encoded or decoded as a current block of pixels in a current picture of a video. The video coder encoder selects a merge candidate from a plurality of merge candidates to obtain a base motion for the current block. The video coder refines the base motion by performing bilateral matching. The video coder refines each motion candidate by one or more refinement passes. The video coder generates a prediction of the current block by selecting a refined motion candidate. The refined motion candidates may be assigned indices for selection according to costs that are determined by template matching. The video coder encodes or decodes the current block by using the generated prediction.

The video coder may derive the motion candidates by applying offsets at different directions to the refined base motion. The different offsets and directions may be associated with MMVD indices. In some embodiments, a motion candidate or the base motion may include multiple subblock-level motion vectors for multiple subblocks of the current block. The refinement passes may include a first refinement pass for refining the motion candidate in a block level by bilateral matching, a second refinement pass for refining the motion candidate in a subblock level by bilateral matching, and a third refinement pass for refining the motion candidate by applying bi-directional optical flow (BDOF) to a result of the second refinement pass.

The video coder generates a prediction of the current block by selecting a refined motion candidate. In some embodiments, the refined motion candidates are assigned indices for selection according to costs. A cost of a motion candidate may be determined based on a comparison between a current template of the current block and a reference template identified by the motion candidate, or determined based on a comparison between subblock templates of the current block and subblock templates identified by subblock motion vectors of the motion candidate.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 conceptually illustrates MMVD candidates and their corresponding offsets.

FIG. 2 shows additional MMVD refinement positions along k×π/8 diagonal angles.

FIG. 3 conceptually illustrates intra block copy (IBC) or current picture referencing (CPR).

FIG. 4 conceptually illustrates template matching based on a search area around an initial motion vector (MV).

FIG. 5 conceptually illustrates a current block having sub-block motion.

FIG. 6 conceptually illustrates refinement of a prediction candidate (e.g., merge candidate) by bilateral matching (BM).

FIG. 7 conceptually illustrates refined MMVD base motion and refined MMVD candidates.

FIG. 8 conceptually illustrates subblock-level refinement by bilateral matching.

FIG. 9 illustrates an example video encoder that may use MMVD to encode pixel blocks.

FIG. 10 illustrates portions of the video encoder that implement MMVD with refinement by bilateral matching and candidate reordering by template matching.

FIG. 11 conceptually illustrates a process for using refined MMVD candidates to encode a pixel block.

FIG. 12 illustrates an example video decoder that may use MMVD to decode and reconstruct pixel blocks.

FIG. 13 illustrates portions of the video decoder that implement MMVD with refinement by bilateral matching and candidate reordering by template matching.

FIG. 14 conceptually illustrates a process for using refined MMVD candidates to decode a pixel block.

FIG. 15 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Merge Mode with Motion Vector Difference (MMVD)

Regular merge mode uses implicitly derived motion information for prediction samples generation of the current CU. Merge Mode with Motion Vector Difference (MMVD) is a coding tool in which the derived motion information under merge mode, as a base motion, is further refined by a motion vector difference MVD. MMVD also extends the list of candidates for merge mode by adding additional MMVD candidates based on predefined offsets (also referred to as MMVD offsets).

A MMVD flag may be signaled after sending a skip flag and merge flag to specify whether MMVD mode is used for a CU. If MMVD mode is used, a selected merge candidate is refined by MVD information. The MVD information also include a merge candidate flag, a distance index to specify motion magnitude, and an index for indication of motion direction. The merge candidate flag is signaled to specify which of the first two merge candidates is to be used as a starting MV.

The distance index is used to specify motion magnitude information by indicating a pre-defined offset from the starting MV. The offset may be added to either horizontal component or vertical component of the starting MV. An example mapping from the distance index to the pre-defined offset is specified in Table I-1 below:

TABLE I-1
Distance Index

| Distance Index | 0 | 1 | 2 | 3 | 4 | 5 | 6 | 7 |
|---|---|---|---|---|---|---|---|---|
| Offset (in unit of luma sample) | ¼ | ½ | 1 | 2 | 4 | 8 | 16 | 32 |

The direction index represents the direction of the MVD relative to the starting point. The direction index can represent one of the four directions as shown in Table I-2.

TABLE I-2
Sign of MV offset specified by direction index

| Direction Index | 00 | 01 | 10 | 11 |
|---|---|---|---|---|
| x-axis | + | − | N/A | N/A |
| y-axis | N/A | N/A | + | − |

It's noted that the meaning of MVD sign may vary according to the information of the starting MV. When the starting MV is an uni-prediction MV or a bi-prediction MV with both lists pointing to the same side of the current picture (i.e., picture order counts or POCs, of the two reference pictures are both larger than the POC of the current picture, or are both smaller than the POC of the current picture), the sign in Table I-2 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), each sign in Table I-2 specifies the sign of the MV offset added to the list0 MV component of starting MV, and the sign for the list1 MV has opposite value. In some embodiments, a predefined offset (MmvdOffset) of a MMVD candidate is derived from or expressed as a distance value (MmvdDistance) and a directional sign (MmvdSign).

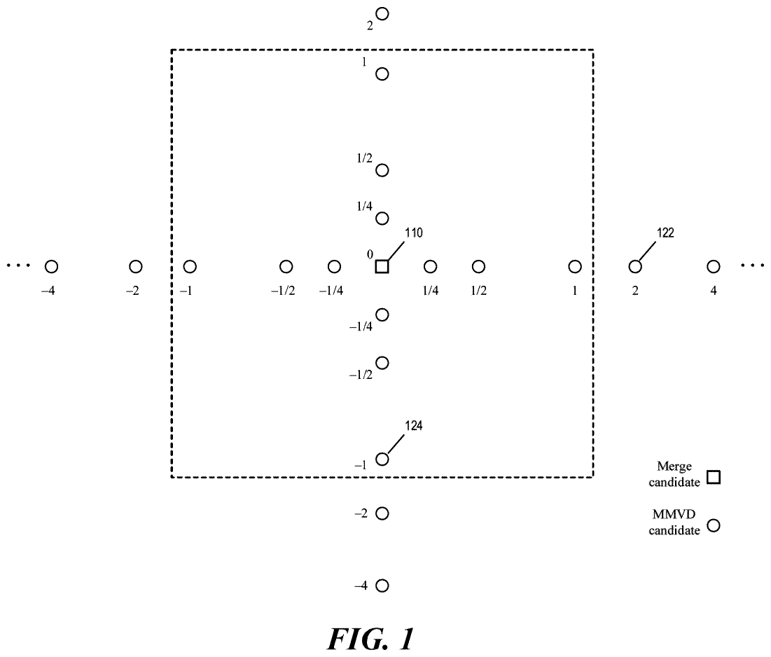

FIG. 1 conceptually illustrates MMVD candidates and their corresponding offsets. The figure illustrates a merge candidate 110 as the starting MV (also referred to as base motion) and several MMVD candidates in the vertical direction and the in the horizontal direction. Each of the MMVD candidate is derived by applying an offset to the starting MV 110. For example, the MMVD candidate 122 is derived by adding offset of 2 to the horizontal component of the merge candidate 110, and the MMVD candidate 124 is derived by adding offset −1 to the vertical component to the merge candidate 110. MMVD candidates with offsets in the horizontal direction, such as the MMVD candidate 122, are referred to as horizontal MMVD candidates. MMVD candidates with offsets in the vertical direction, such as the MMVD candidate 124, are referred to as vertical MMVD candidates.

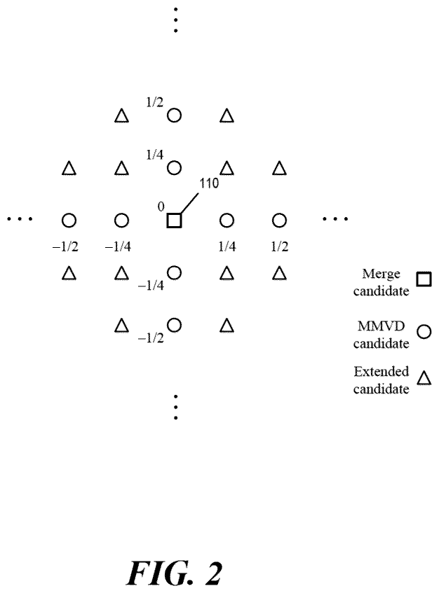

The MMVD offsets may be extended for regular MMVD and affine MMVD modes. Additional refinement positions along k×π/8 diagonal angles are added, thereby increasing the number of directions from 4 to 16. FIG. 2 shows additional MMVD refinement positions along k×π/8 diagonal angles.

### II. Intra Block Copy (IBC) or Current Picture Referencing (CPR)

Motion Compensation is a video coding process that explores the pixel correlation between adjacent pictures. It is generally assumed that in a video sequence the patterns corresponding to objects or background in a frame are displaced to form corresponding objects on the subsequent frame or correlated with other patterns within the current frame. With the estimation of such a displacement (e.g., using block matching techniques), the pattern could be mostly reproduced without needing to re-code the pattern. Block matching and copy allows selecting the reference block from within the same picture, but it is observed to be not as efficient when applied to camera captured videos. Part of the reasons is that textual pattern in a spatial neighboring area may be similar to the current coding block but usually with some gradual changes over space. It is therefore less likely for a block to find a good match within the same picture of a camera captured video, thereby limiting the improvement in coding performance.

However, the spatial correlation among pixels within the same picture is different for screen content. For a typical video with text and graphics, there are usually repetitive patterns within the same picture. Hence, intra (picture) block compensation has been observed to be very effective. The prediction mode intra block copy (IBC) mode or current picture referencing (CPR) may therefore be used for screen content coding.

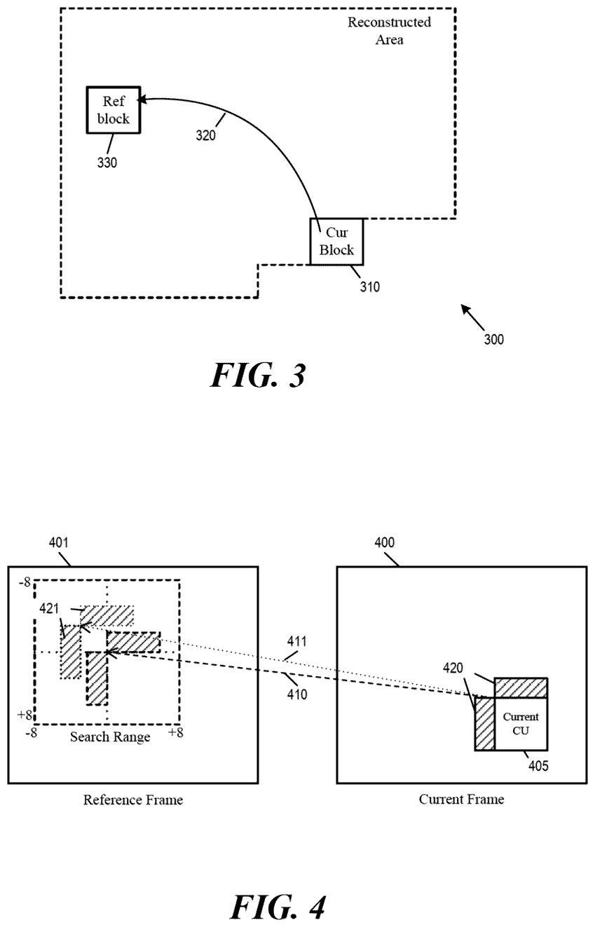

FIG. 3 conceptually illustrates intra block copy (IBC) or current picture referencing (CPR). As illustrated, a prediction unit (PU) as a current block 310 is predicted from a previously reconstructed block 330 within the same picture 300. A displacement vector 320 (called block vector or BV) is used to signal the relative displacement from the position of the current block to that of the reference block, which provides the reference samples used for generating a predictor of the current block. The prediction errors are then coded using transformation, quantization and entropy coding. The reference samples may correspond to the reconstructed samples of the current decoded picture prior to in-loop filter operations, both deblocking and sample adaptive offset (SAO) filters.

### III. Decoder-Side Refinement

a. Template Matching (TM)

Template matching (TM) is a decoder-side MV derivation method to refine the motion information of the current CU by finding the closest match between a template of the current CU (e.g., top and/or left neighbouring blocks of the current CU) in the current picture and a set of pixels (i.e., same size to the template) in a reference picture.

FIG. 4 conceptually illustrates template matching based on a search area around an initial motion vector (MV). As illustrated, for a current CU 405 in a current picture 400, the video coder searches the reference picture or frame 401 within a [−8, +8]-pel search range around an initial MV 410 for a better or refined MV 411. The search is based on minimizing the difference (or cost) between a current template 420 neighboring the current block 405 and a reference template 421 identified by the refined MV 411. The template matching may be performed with a search step size that is determined based on an adaptive motion vector resolution mode (AMVR). The template matching process can be cascaded with a bilateral matching process in merge modes.

In advanced motion vector prediction (AMVP) mode, an MVP candidate is determined based on template matching error to select the one that reaches the minimum difference between the current block template and the reference block template, and then TM is performed only for this particular MVP candidate for MV refinement. The TM process refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on a AMVR mode search pattern according to Table III-1 below.

TABLE III-1
Search patterns of AMVR and merge mode with AMVR

| | AMVR mode | | | | Merge mode | |
|---|---|---|---|---|---|---|
| | 4- | Full- | Half- | Quarter- | AltIF = | AltIF = |
| Search pattern | pel | pel | pel | pel | 0 | 1 |
| 4-pel diamond | v | | | | | |
| 4-pel cross | v | | | | | |
| Full-pel diamond | | v | v | v | v | v |
| Full-pel cross | | v | v | v | v | v |
| Half-pel cross | | | v | v | v | v |
| Quarter-pel cross | | | | v | v | |
| ⅛-pel cross | | | | | v | |

This search process ensures that the MVP candidate still keeps the same MV precision as indicated by the AMVR mode after the TM process. In the search process, if the difference between the previous minimum cost and the current minimum cost in the iteration is less than a threshold that is equal to the area of the block, the search process terminates.

In some embodiments, when using merge mode, the video coder may apply a similar TM search method to refine the merge candidate indicated by the merge index. As Table 1 above shows, TM may be performed all the way down to ⅛-pel MVD precision or skipping those beyond half-pel MVD precision, depending on whether an alternative interpolation filter (that is used when AMVR is of half-pel mode) is used according to merged motion information. In addition, when TM mode is enabled, template matching may work as an independent process or as an extra MV refinement process between block-based and subblock-based bilateral matching (BM) methods, depending on whether BM can be enabled or not according to its enabling condition check.

Adaptive Reordering of Merge Candidates with Template Matching (ARMC-TM) is a method to re-order merge candidates based on template-matching (TM) cost, where signaling efficiency is improved by sorting merge candidates in ascending order of TM costs. For the ARMC-TM, or TM merge mode, merge candidates are reordered before the refinement process. The template matching cost of a merge candidate may be measured by the sum of absolute differences (SAD) between samples of the current template 420 of the current block and their corresponding reference samples in the reference template 421.

In some embodiments, after a merge candidate list is constructed, merge candidates are divided into several subgroups. The subgroup size is set to 5 for regular merge mode and TM merge mode. The subgroup size is set to 3 for affine merge mode. Merge candidates in each subgroup are reordered ascendingly according to cost values based on template matching. In some embodiments, merge candidates in the last but not the first subgroup are not reordered.

For subblock-based merge candidates with subblock size equal to Wsub×Hsub, the above template may include several sub-templates with the size of Wsub×1, and the left template includes several sub-templates with the size of 1×Hsub. In some embodiments, the motion information of the subblocks in the first row and the first column of current block is used to derive the reference samples of each sub-template.

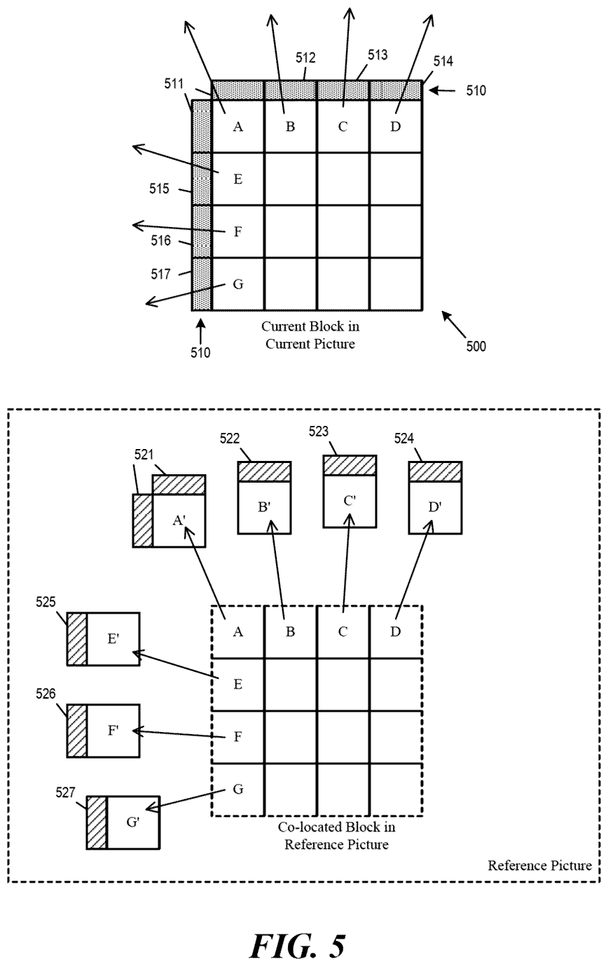

FIG. 5 conceptually illustrates a current block 500 having sub-block motion. The current block 500 is coded by using the motion information of the subblocks in the first row and the first column (subblocks A-G) of the current block. The motion information of subblocks A-G are used to identify reference subblocks A′-G′ in a reference picture. The current block 500 has a neighboring template 510, which includes sub-templates (or subblock templates) 511-517 that neighbors subblocks A-G, respectively, that are above and left of the current block 500. The reference subblocks A′-G′ has corresponding neighboring reference sub-templates 521-527 in the reference picture. The TM costs of the motion information of the different subblocks can be computed by matching the sub-templates 511-517 with the corresponding respective sub-templates 521-527.

b. Decoder Motion Vector Refinement (DMVR)

In order to increase the accuracy of the MVs of the merge mode, a bilateral-matching (BM) based decoder side motion vector refinement can be applied to refine MVs. In bi-prediction operation, a refined MV is searched around the initial MVs in the reference picture list L0 and reference picture list L1. The BM method calculates the distortion between the two candidate blocks in the reference picture list L0 and list L1. The MV candidate with the lowest SAD becomes the refined MV and used to generate the bi-predicted signal.

In some embodiments, a multi-pass decoder-side motion vector refinement (MP-DMVR) method is applied in regular merge mode if the selected merge candidate meets the DMVR conditions. In the first pass, bilateral matching (BM) is applied to the coding block. In the second pass, BM is applied to each 16×16 subblock within the coding block. In the third pass, MV in each 8×8 subblock is refined by applying bi-directional optical flow (BDOF). The BM refines a pair of motion vectors MV0 and MV1 under the constraint that motion vector difference MVD0 (i.e., MV0′−MV0) is just the opposite sign of motion vector difference MVD1 (i.e., MV1′−MV1).

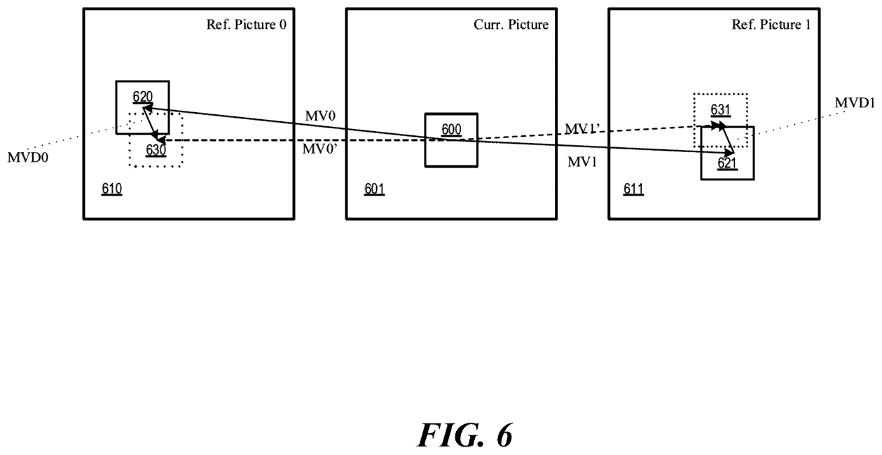

FIG. 6 conceptually illustrates refinement of a prediction candidate (e.g., merge candidate) by bilateral matching (BM). MV0 is an initial motion vector or a prediction candidate, MV1 is the mirror of MV0. MV0 references an initial reference block 620 in reference picture 610. MV1 references an initial reference block 621 in a reference picture 611. The figure shows MV0 and MV1 being refined to form MV0′ and MV1′, which updated reference blocks 630 and 631, respectively. The refinement is performed according to bilateral matching, such that the refined motion vector pair MV0′ and MV1′ has better bilateral matching cost than the initial motion vector pair MV0 and MV1. MV0′-MV0 (i.e., MVD0) and MV1′−MV1 (i.e., MVD1) are constrained to be equal in magnitude but opposite in direction. In some embodiments, the bilateral matching cost of a pair of mirrored motion vectors (e.g., MV0 and MV1) is calculated based on the difference between the two reference blocks referred by the mirrored motion vectors (e.g., difference between the reference blocks 620 and 621).

### IV. Multi-Hypothesis Prediction (MH)

Multi-hypothesis prediction is used to improve the existing prediction modes in inter pictures, including uni-prediction of advanced motion vector prediction (AMVP) mode, skip and merge mode, and intra mode. MH prediction combines an existing prediction mode with an extra merge indexed prediction. The merge indexed prediction is performed as in merge mode, where a merge index is signaled to acquire motion information for the motion compensated prediction. The final prediction is a weighted average of the merge indexed prediction and the prediction generated by the existing prediction mode, where different weights are applied depending on the combinations.

### V. TM-Based MMVD

a. TM Based Reordering for MMVD and Affine MMVD

In some embodiments, all the possible MMVD refinement positions (16×6) for each base candidate are reordered based on the SAD cost between the template (one row above and one column left to the current block) and its reference for each refinement position. The top ⅛ refinement positions with the smallest template SAD costs are kept as available positions, consequently for MMVD index coding. The MMVD index is binarized by the rice code with the parameter equal to 2. The affine MMVD reordering is extended, in which additional refinement positions along k×π/4 diagonal angles are added. After reordering top ½ refinement positions with the smallest template SAD costs are kept.

The first N motion candidates in the candidate list before being reordered may be utilized as the base candidates for MMVD and affine MMVD. N is equal to 3 for MMVD, and [1, 3] depending on the neighboring block affine flags for affine MMVD. There are two ways of adding MMVD offsets (“one-side” and “two-side”), depending on whether the offset of the other reference picture list is mirrored or directly set to zero. TM cost may be used to determine which is applied to the current block.

b. MMVD Multi-Stage Refinement with Template Matching

In some embodiments, for MMVD, 6 different steps and 16 different directions form 96 different MVD positions for each base motion (merge candidate). If the base motion is bi-prediction, 3 possible methods may apply to the MMVD offset, i.e., only add to L0, only add to L1, or add to both L0 and L1. Thus, a total number of 96 candidates, for uni-prediction, or 96*3 candidates, for bi-prediction, are reordered based on template matching (TM) costs. TM costs of all candidates maybe compared at the same time, in a single stage.

In some embodiments, multi-stage TM-based reordering is used. Such TM-based reordering includes the following steps:
1. Determine an initial set of candidates C₀
2. Reorder the candidates in C₀ based on TM costs and take the best K₀ candidates to form a subset D₀
3. Generate an expanded candidate set C₁ by introducing more candidates similar to the candidates in D₀
4. Reorder the candidates in C₁ based on TM costs and take the best K₁ candidates to form a subset D₁
5. Repeat step 3 and step 4: generate an expanded candidate set Cᵢ by introducing more candidates similar to the candidates in Dᵢ₋₁; reorder the candidates in Cᵢ based on TM costs and take the best Kᵢ candidates to form a subset Dᵢ
6. After additional T refinements, the candidate set D_{T} is used for further selection. That is, encoder/decoder will select/receive one index to indicate which candidate in D_{T} is used.

In some embodiments, the expanded candidate set Cᵢ is generated by introducing more candidates similar to the candidates in Dᵢ₋₁ in terms of MVD positions. Specifically, when generating an expanded candidate set from a previously reordered candidate set, new candidates with similar MVD positions are added into the expanded candidate set. The similar MVD position could be derived by modifying the MVD step or by searching the neighboring positions.

In some embodiments, the expanded candidate set of MVD positions are derived by modifying the MVD step. The initial candidate set C₀ includes 96 candidates, but the MVD steps are modified to {s, 2s, 3s, 4s, 5s, 6s}, where s is an integer greater than 1. After a first TM-based reordering, the best K₀ candidates are kept as Do. When generating the expanded candidate set C₁ from D₀, for each candidate in D₀, two new candidates with step+(s/2) and step−(s/2) are introduced. The candidates in D₀ and the two new candidates form the candidate set C₁, resulting in 3*K₀ candidates in C₁. Note that some redundant candidates in the expanded set could be pruned or be replaced by another candidates (e.g., if the step of one candidate in D₀ is s and the other is 2s, s+(s/2) and 2s−(s/2) result in the same candidate). In general, when generating the expanded candidate set Cᵢ from Dᵢ₋₁, for each candidate in Dᵢ₋₁, two candidates with step+(s/2ⁱ) and step-(s/2ⁱ) are added. This process is repeated until s/21 is small enough.

In some embodiments, the expanded candidate set of MVD positions are derived by searching the neighboring positions. The initial candidate set C₀ is composed of 96 candidates. After a first TM-based reordering, the best K₀ candidates are kept as D₀. When generating the expanded candidate set C₁ from D₀, for each candidate in D₀, let (x,y) be the MVD of the candidate, eight new candidates with MVD position (x−s, y−s), (x, y−s), (x+s, y−s), (x−s, y), (x+s, y), (x−s, y+s), (x, y+s), and (x+s, y+s) are introduced. The candidates in D₀ and the eight new candidates form the candidate set C₁, resulting in 9*K₀ candidates in C₁. Note that some redundant candidates in the expanded set may be pruned or be replaced by another candidates. The value of s may be reduced after one iteration, and the search process is repeated until the value of s is small enough.

In some embodiments, the expanded candidate set Cᵢ is generated by introducing more candidates similar to the candidates in Dᵢ₋₁, where the difference between new candidates and candidates in Dᵢ₋₁ is how to apply MVD to each reference picture list. Specifically, when generating an expanded candidate set from a previously reordered candidate set, new candidates with different methods for applying MVD to each reference picture list are added into the expanded candidate set.

In some embodiments, the initial candidate set C₀ includes 96 candidates, with the MVD applied to both L0 and L1. When generating the expanded candidate set C₁ from D₀, for each candidate in D₀, two new candidates are introduced. One applies MVD to only L0, while the other applies MVD to only L1. The original candidates in D₀ and the two new candidates form the candidate set C₁, resulting in 3*K₀ candidates in C₁. In some embodiments, more than two additional candidates may be added by introducing more methods of applying MVD. For example, the video coder may add MVD multiplied by a first scaling factor to L0, while add MVD multiplied by a second scaling factor to L1.

In some embodiments, the expanded candidate set Cᵢ is generated by introducing more candidates similar to the candidates in Dᵢ₋₁, where the difference between new candidates and candidates in Dᵢ₋₁ is BCW index. Specifically, when generating an expanded candidate set from a previously reordered candidate set, new candidates with different BCW indices are added into the expanded candidate set.

The above refinement methods could be combined. For example, in some embodiments, the first two iterations (C₀ to D₀ and Cᵢ to Dᵢ) refine the MVD positions, the third iteration (C₂ to D₂) refines how to apply MVD to each reference picture list, and the last iteration (C₃ to D₃) refines the BCW index.

In some embodiments, diversity reordering could be applied. In one embodiment, diversity reordering is applied in each iteration; in another embodiment, diversity reordering is only applied in the iterations that refine MVD positions; in yet another embodiment, diversity reordering is only applied in the last iteration. Specifically, all possible candidates in all or some of the iterations are collected, and the collected candidates are reordered.

In some embodiments, if two or more bases (of motion for MMVD) are similar, the values of Kᵢ could be changed adaptively. For example, if two bases are similar, the final candidate list is generated based on one of the bases to reduce redundancy, and the number of to-be-kept candidates is doubled. In such design, either only Kr in the last iteration is doubled, or all the Kᵢ are doubled.

The foregoing proposed methods can be implemented in encoders and/or decoders. For example, the proposed method can be implemented in a inter prediction module of an encoder, and/or an inter prediction module of a decoder.

### VI. MMVD with Bilateral Matching (BM) Refinement

Some embodiments of the disclosure provide methods of refining MMVD prediction by applying bilateral matching (BM). In some embodiments, the base motion of MMVD (derived from the corresponding merge candidate) is refined by BM. In some embodiments, a CU-level BM refinement is used to refine the MMVD base motion in a MP-DMVR first pass, and motion candidates (MMVD candidates) are derived based on the refined MMVD base motion by applying different offsets in different directions. In some embodiments, the derived motion candidates (MMVD candidates) are further refined by BM to become refined MMVD candidates.

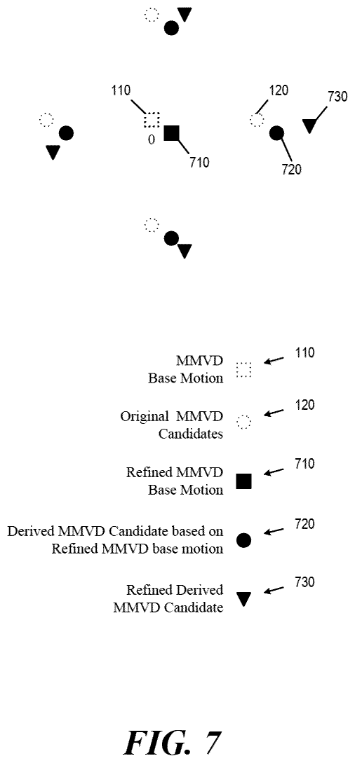

FIG. 7 conceptually illustrates refined MMVD base motion and refined MMVD candidates. The figure illustrates the original MMVD base motion 110 that is from a merge candidate. BM is performed to refine the MMVD base motion 110 to obtain a refined MMVD base motion 710. Different offsets in different directions are applied to the refined MMVD base motion 710 to obtain MMVD candidates 720. BM refinement may be performed on the derived MMVD candidates 720 to become the refined MMVD candidates 730.

In some embodiments, a MMVD candidate or the MMVD base motion itself may include subblock level motion information (e.g., an affine motion field), and the refinement of the MMVD candidate may include refining each subblock level motion information by BM.

In some embodiments, the derived MMVD candidates 720 are refined by one or more MP-DMVR passes to become the refined MMVD candidates 730. For example, in MP-DMVR pass 1, CU-level BM refinement may be used to refine the MMVD candidates 720; in MP-DMVR pass 2, subblock-level BM refinement may be used to refine the MMVD candidates 720; and in MP-DMVR pass 3, BDOF algorithm is used to refine the MMVD candidates 720. In some embodiments, the video coder may perform some but not all MP-DMVR passes. For example, the video coder may perform only MP-DMVR pass 1 and pass 3 for refining a MMVD candidate (thereby skipping the subblock level refinement in MP-DMVR pass 2.)

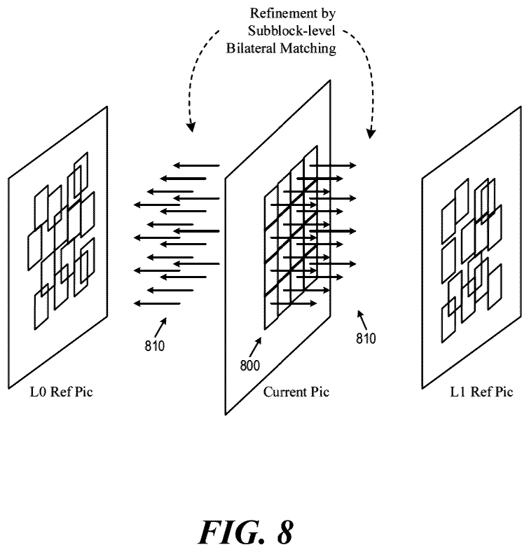

FIG. 8 conceptually illustrates subblock-level refinement by bilateral matching. The figure illustrates a current block 800 for which a merge candidate is selected. The selected merge candidate divides the current block 800 into 4×4 subblocks, and provides a motion field of bidirectional motion vectors for those subblocks. Each bidirectional motion vector references positions in a L0 reference picture and a L1 reference picture. For a particular MMVD candidate based on the selected merge candidate, with offset and direction applied to the motion field 810, subblock-level BM is performed on each bidirectional motion vector in the motion field 810 to refine the MMVD candidate.

In some embodiments, the refined MMVD candidates 730 are reordered (e.g., assigned indices) based on bilateral matching cost. In that, if a candidate's reference block L0 and reference block L1 are similar, the bilateral matching cost of this candidate will be small. It will be moved toward the front of the candidate list and be signaled with shorter codeword. In some embodiments, the MMVD candidate's reference block L0 and reference block L1 may include more than one subblocks with different subblock MVs, as described by reference to FIG. 8 above. In some embodiments, the refined MMVD candidates will be reordered based on template matching costs of the candidates. In that, the template of a MMVD candidate may include more than one subblock templates. Computing the template matching cost of a motion vector (e.g., a refined MMVD candidate) is described by reference to FIG. 4 above. Subblock templates are described by reference to FIG. 5 above.

In some embodiments, MMVD candidates, refined MMVD candidates type1, refined MMVD candidates type2, and refined MMVD candidates type3 can be reordered together. And the best N candidates will be selected after reordering. In that, refined MMVD candidates type1 are MMVD candidates refined by MP-DMVR pass 1. The refined MMVD candidates type2 are MMVD candidates refined by MP-DMVR pass 1 and MP-DMVR pass 2. The refined MMVD candidates type3 are MMVD candidates refined by MP-DMVR pass 1, MP-DMVR pass 2 and MP-DMVR pass 3.

In some embodiments, before reordering, the cost of refined MMVD candidate type1, type2 and type3 are modified. For example, the final costs of type1 (refined by pass 1) candidates are the calculated BM cost multiplying by N. The final costs of type2 candidates (refined by passes 1 and 2) are the calculated BM cost multiplying by M. The final costs of type3 candidates (refined by passes 1, 2, and 3) are the calculated BM cost multiplying by R. In some embodiments, R>N>M>1.

In some embodiments, a flag (e.g., a CU-level flag) is signaled to indicate whether a MMVD candidate is refined by MP-DMVR or not. In some embodiments, a merge list is generated for MMVD base candidates. In that, all MMVD base candidates in the merge list shall be true-bi prediction.

In some embodiments, MMVD with BM refinement as described above may be enabled or disabled, according to one or a combination of the selected reference pictures indices, temporal distance between reference picture and current picture, quantization parameter, the coded information of current CU, prediction mode, motion vectors, motion vector resolution, residual of current CU, and reference samples.

### VII. AMVP with BM Refinement

In some embodiments, after motion estimation, a bi-prediction AMVP predictor can be further refined by BM. In that, MP-DMVR pass 3 are used (BDOF algorithm related refinement). In some embodiments, the BM refinement can only be applied to integer-pel motion resolution. In some embodiments, the bi-prediction AMVP motion is a true bi-prediction. In some embodiment, after motion estimation, a bi-prediction AMVP predictor can be further refined by BM. In that, MP-DMVR pass 3 are used (BDOF algorithm related refinement).

In some embodiments, the BM refinement can only be applied to integer-pel motion resolution. In some embodiments, the bi-prediction AMVP motion shall be a true-bi prediction. In some embodiments, the on-off of the BM refinement of AMVP mode is indicated implicitly without signaling any additional flag. For example, after motion estimation, an initial BM cost is derived. If the initial BM cost is larger than a pre-defined threshold, the AMVP predictor will be further refined by BM. Otherwise, BM refinement is not applied. The pre-defined threshold is a value related to block size. For another example, BM refinement is applied only if a CU's size is larger than a pre-defined threshold.

In some embodiment, the bi-prediction AMVP predictor refined by BM cannot be an AMVP-Merge candidate.

In some embodiments, the AMVP with BM refinement method described above is enabled or disabled, according to one or the combination of the selected reference pictures indices, temporal distance between reference picture and current picture, quantization parameter, the coded information of current CU, prediction mode, motion vectors, motion vector resolution, residual of current CU, and reference samples.

### VIII. BDOF Displacement Fusion

In some embodiments, in MP-DMVR pass 3, a CU may be partitioned into several subblocks, and the corresponding motion refinements will be derived based on BDOF algorithm. In some embodiments, neighboring subblocks' displacements are averaged to generate the final displacement of current subblock. In that, the difference between each subblock displacement will be decreased.

For example, in some embodiments, the displacements of top neighboring subblock, left neighboring subblock, right neighboring subblock, and bottom neighboring subblock are averaged with currently derived subblock displacement. And the averaged subblock displacement will be the final displacement of current subblock.

In some embodiments, a set of weighting values may be used to calculate the final displacement. The weighing values for the derived displacement on current subblock is larger than other subblocks. In some embodiments, a set of weighting values can be specified to calculate the final displacement. And the weighting values of each subblock displacement are specified based on the distances between the neighboring subblocks and the current subblock. For the subblocks closer to current subblock, higher weighting values may be used.

In some embodiment, the subblock-based displacements fusion method can also be applied on MP-DMVR pass 4. In some embodiment, the number of neighboring subblocks used for averaging is designed based on CU size, picture size, QP, or current CU prediction mode. In some embodiments, one on/off control flag is signaled at CU level, slice level, picture level, and/or sequence level to indicate whether to enable the subblock-based displacements fusion method.

In some embodiment, the subblock-based displacement fusion method described above is enabled or disabled, according to one or the combination of the selected reference pictures indices, temporal distance between reference picture and current picture, quantization parameter, the coded information of current CU, prediction mode, motion vectors, motion vector resolution, residual of current CU, and reference samples.

Any of the foregoing proposed methods can be implemented in encoders and/or decoders. For example, any of the proposed methods can be implemented in MP-DMVR module of an encoder and/or a decoder. Alternatively, any of the proposed methods can be implemented as a circuit coupled to MP-DMVR module of the encoder and/or the decoder.

### IX. Example Video Encoder

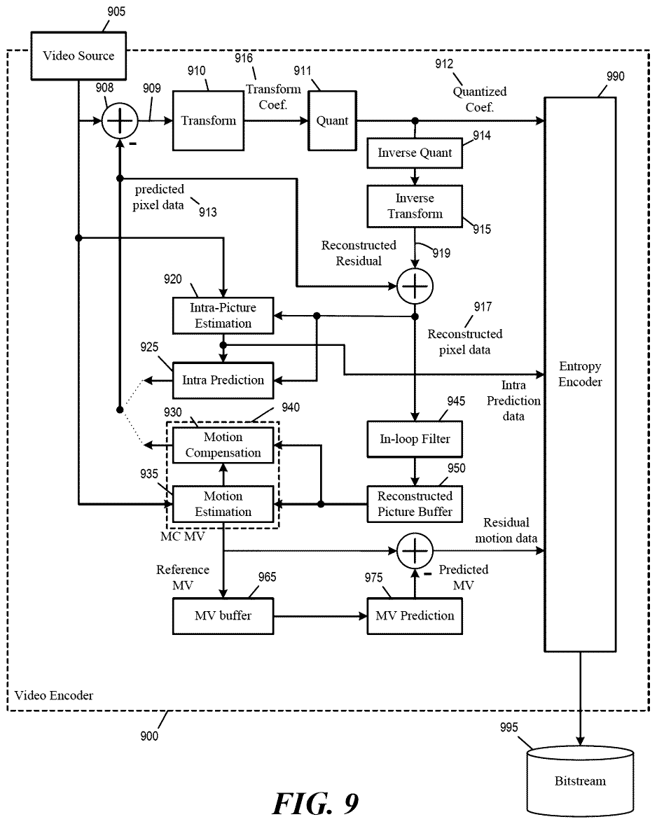

FIG. 9 illustrates an example video encoder 900 that may use MMVD to encode pixel blocks. As illustrated, the video encoder 900 receives input video signal from a video source 905 and encodes the signal into bitstream 995. The video encoder 900 has several components or modules for encoding the signal from the video source 905, at least including some components selected from a transform module 910, a quantization module 911, an inverse quantization module 914, an inverse transform module 915, an intra-picture estimation module 920, an intra-prediction module 925, a motion compensation module 930, a motion estimation module 935, an in-loop filter 945, a reconstructed picture buffer 950, a MV buffer 965, and a MV prediction module 975, and an entropy encoder 990. The motion compensation module 930 and the motion estimation module 935 are part of an inter-prediction module 940.

In some embodiments, the modules 910-990 are modules of software instructions being executed by one or more processing units (e.g., a processor) of a computing device or electronic apparatus. In some embodiments, the modules 910-990 are modules of hardware circuits implemented by one or more integrated circuits (ICs) of an electronic apparatus. Though the modules 910-990 are illustrated as being separate modules, some of the modules can be combined into a single module.

The video source 905 provides a raw video signal that presents pixel data of each video frame without compression. A subtractor 908 computes the difference between the raw video pixel data of the video source 905 and the predicted pixel data 913 from the motion compensation module 930 or intra-prediction module 925 as prediction residual 909. The transform module 910 converts the difference (or the residual pixel data or residual signal 908) into transform coefficients (e.g., by performing Discrete Cosine Transform, or DCT). The quantization module 911 quantizes the transform coefficients into quantized data (or quantized coefficients) 912, which is encoded into the bitstream 995 by the entropy encoder 990.

The inverse quantization module 914 de-quantizes the quantized data (or quantized coefficients) 912 to obtain transform coefficients, and the inverse transform module 915 performs inverse transform on the transform coefficients to produce reconstructed residual 919. The reconstructed residual 919 is added with the predicted pixel data 913 to produce reconstructed pixel data 917. In some embodiments, the reconstructed pixel data 917 is temporarily stored in a line buffer (not illustrated) for intra-picture prediction and spatial MV prediction. The reconstructed pixels are filtered by the in-loop filter 945 and stored in the reconstructed picture buffer 950. In some embodiments, the reconstructed picture buffer 950 is a storage external to the video encoder 900. In some embodiments, the reconstructed picture buffer 950 is a storage internal to the video encoder 900.

The intra-picture estimation module 920 performs intra-prediction based on the reconstructed pixel data 917 to produce intra prediction data. The intra-prediction data is provided to the entropy encoder 990 to be encoded into bitstream 995. The intra-prediction data is also used by the intra-prediction module 925 to produce the predicted pixel data 913.

The motion estimation module 935 performs inter-prediction by producing MVs to reference pixel data of previously decoded frames stored in the reconstructed picture buffer 950. These MVs are provided to the motion compensation module 930 to produce predicted pixel data.

Instead of encoding the complete actual MVs in the bitstream, the video encoder 900 uses MV prediction to generate predicted MVs, and the difference between the MVs used for motion compensation and the predicted MVs is encoded as residual motion data and stored in the bitstream 995.

The MV prediction module 975 generates the predicted MVs based on reference MVs that were generated for encoding previously video frames, i.e., the motion compensation MVs that were used to perform motion compensation. The MV prediction module 975 retrieves reference MVs from previous video frames from the MV buffer 965. The video encoder 900 stores the MVs generated for the current video frame in the MV buffer 965 as reference MVs for generating predicted MVs.

The MV prediction module 975 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 995 by the entropy encoder 990.

The entropy encoder 990 encodes various parameters and data into the bitstream 995 by using entropy-coding techniques such as context-adaptive binary arithmetic coding (CABAC) or Huffman encoding. The entropy encoder 990 encodes various header elements, flags, along with the quantized transform coefficients 912, and the residual motion data as syntax elements into the bitstream 995. The bitstream 995 is in turn stored in a storage device or transmitted to a decoder over a communications medium such as a network.

The in-loop filter 945 performs filtering or smoothing operations on the reconstructed pixel data 917 to reduce the artifacts of coding, particularly at boundaries of pixel blocks. In some embodiments, the filtering or smoothing operations performed by the in-loop filter 945 include deblock filter (DBF), sample adaptive offset (SAO), and/or adaptive loop filter (ALF).

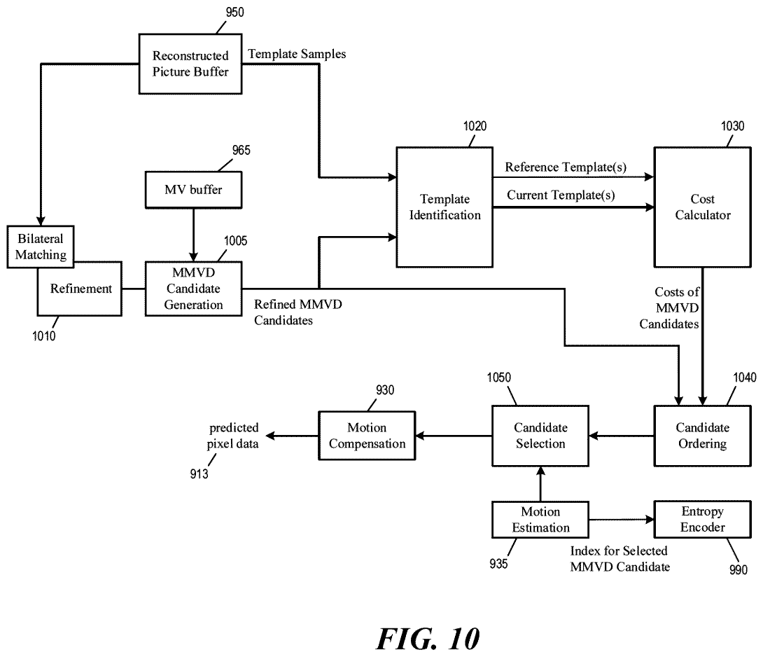

FIG. 10 illustrates portions of the video encoder 900 that implement MMVD with refinement by bilateral matching and candidate reordering by template matching. As illustrated, a merge candidate is selected from the MV buffer 965 by the motion estimation module 935 and provided to a MMVD candidate generation module 1005, which generates MMVD candidates based on the selected merge candidate as the MMVD base motion (by adding different offsets at different directions). A refinement module 1010 refines the generated MMVD candidates by performing bilateral matching (using reference pictures stored in the reconstructed picture buffer 950) and/or BDOF operations in one or more passes in a manner similar to MP-DMVR. The bilateral matching may be performed at CU-level and/or subblock-level in different refinement passes to refine the MMVD candidates.

For each (refined) MMVD candidate, a template identification module 1020 retrieves samples for a current template and a reference template from the reconstructed picture buffer 950. The retrieved templates are provided to a cost calculator 1030, which performs template matching to produce a cost for each MMVD candidate. The computed costs of the various MMVD candidates are provided to a candidate ordering module 1040, which assigns indices to the various (refined) MMVD candidates according to their corresponding computed TM costs.

A candidate selection module 1050 may select one of the MMVD candidates from the candidate ordering module 1040. The motion compensation module 930 performs motion compensation by using the selected MMVD candidate to generate a predictor for the current block as the predicted pixel data 913. An index of the selected MMVD candidate may be provided to the entropy encoder 990 to be signaled in bitstream 995. In some embodiments, the selection of the MMVD candidate is determined by the motion estimation module 935.

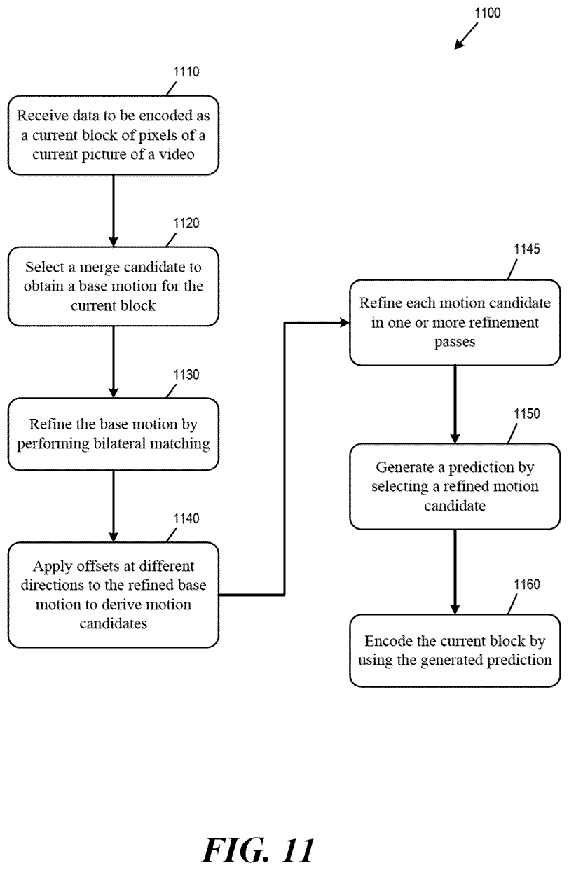

FIG. 11 conceptually illustrates a process 1100 for using refined MMVD candidates to encode a pixel block. In some embodiments, one or more processing units (e.g., a processor) of a computing device implementing the encoder 900 performs the process 1100 by executing instructions stored in a computer readable medium. In some embodiments, an electronic apparatus implementing the encoder 900 performs the process 1100.

The encoder receives (at block 1110) data to be encoded as a current block of pixels in a current picture of a video. The encoder selects (at block 1120) a merge candidate from a plurality of merge candidates to obtain a base motion for the current block. The encoder refines (at block 1130) the base motion by performing bilateral matching.

The encoder derives (at block 1140) motion candidates (e.g., MMVD candidates) from the refined base motion by e.g., applying offsets at different directions to the refined base motion. The different offsets and directions may be associated with MMVD indices. In some embodiments, a motion candidate or the base motion may include multiple subblock-level motion vectors for multiple subblocks of the current block.

The encoder refines (at block 1145) each motion candidate by one or more refinement passes, such as a first refinement pass for refining the motion candidate in a block level by bilateral matching, a second refinement pass for refining the motion candidate in a subblock level by bilateral matching, and a third refinement pass for refining the motion candidate by applying bi-directional optical flow (BDOF) to a result of the second refinement pass.

The encoder generates (at block 1150) a prediction of the current block by selecting a refined motion candidate. In some embodiments, the refined motion candidates are assigned indices for selection according to costs. A cost of a motion candidate may be determined based on a comparison between a current template of the current block and a reference template identified by the motion candidate, or determined based on a comparison between subblock templates of the current block and subblock templates identified by subblock motion vectors of the motion candidate. The encoder encodes (at block 1160) the current block by using the generated prediction to produce prediction residuals.

### X. Example Video Decoder

In some embodiments, an encoder may signal (or generate) one or more syntax element in a bitstream, such that a decoder may parse said one or more syntax element from the bitstream.

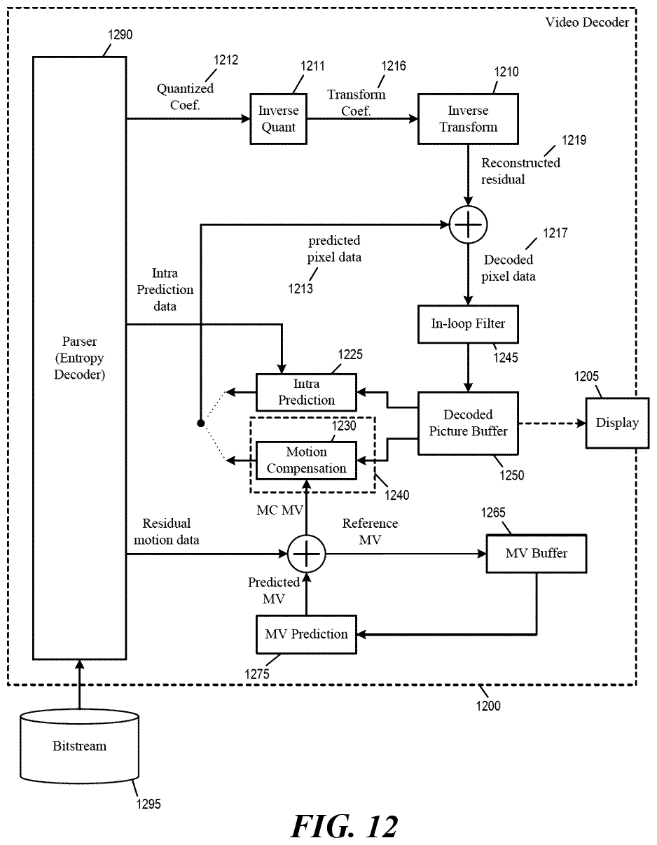

FIG. 12 illustrates an example video decoder 1200 that may use MMVD to decode and reconstruct pixel blocks. As illustrated, the video decoder 1200 is an image-decoding or video-decoding circuit that receives a bitstream 1295 and decodes the content of the bitstream into pixel data of video frames for display. The video decoder 1200 has several components or modules for decoding the bitstream 1295, including some components selected from an inverse quantization module 1211, an inverse transform module 1210, an intra-prediction module 1225, a motion compensation module 1230, an in-loop filter 1245, a decoded picture buffer 1250, a MV buffer 1265, a MV prediction module 1275, and a parser 1290. The motion compensation module 1230 is part of an inter-prediction module 1240.

In some embodiments, the modules 1210-1290 are modules of software instructions being executed by one or more processing units (e.g., a processor) of a computing device. In some embodiments, the modules 1210-1290 are modules of hardware circuits implemented by one or more ICs of an electronic apparatus. Though the modules 1210-1290 are illustrated as being separate modules, some of the modules can be combined into a single module.

The parser 1290 (or entropy decoder) receives the bitstream 1295 and performs initial parsing according to the syntax defined by a video-coding or image-coding standard. The parsed syntax element includes various header elements, flags, as well as quantized data (or quantized coefficients) 1212. The parser 1290 parses out the various syntax elements by using entropy-coding techniques such as context-adaptive binary arithmetic coding (CABAC) or Huffman encoding.

The inverse quantization module 1211 de-quantizes the quantized data (or quantized coefficients) 1212 to obtain transform coefficients, and the inverse transform module 1210 performs inverse transform on the transform coefficients 1216 to produce reconstructed residual signal 1219. The reconstructed residual signal 1219 is added with predicted pixel data 1213 from the intra-prediction module 1225 or the motion compensation module 1230 to produce decoded pixel data 1217. The decoded pixels data are filtered by the in-loop filter 1245 and stored in the decoded picture buffer 1250. In some embodiments, the decoded picture buffer 1250 is a storage external to the video decoder 1200. In some embodiments, the decoded picture buffer 1250 is a storage internal to the video decoder 1200.

The intra-prediction module 1225 receives intra-prediction data from bitstream 1295 and according to which, produces the predicted pixel data 1213 from the decoded pixel data 1217 stored in the decoded picture buffer 1250. In some embodiments, the decoded pixel data 1217 is also stored in a line buffer (not illustrated) for intra-picture prediction and spatial MV prediction.

In some embodiments, the content of the decoded picture buffer 1250 is used for display. A display device 1205 either retrieves the content of the decoded picture buffer 1250 for display directly, or retrieves the content of the decoded picture buffer to a display buffer. In some embodiments, the display device receives pixel values from the decoded picture buffer 1250 through a pixel transport.

The motion compensation module 1230 produces predicted pixel data 1213 from the decoded pixel data 1217 stored in the decoded picture buffer 1250 according to motion compensation MVs (MC MVs). These motion compensation MVs are decoded by adding the residual motion data received from the bitstream 1295 with predicted MVs received from the MV prediction module 1275.

The MV prediction module 1275 generates the predicted MVs based on reference MVs that were generated for decoding previous video frames, e.g., the motion compensation MVs that were used to perform motion compensation. The MV prediction module 1275 retrieves the reference MVs of previous video frames from the MV buffer 1265. The video decoder 1200 stores the motion compensation MVs generated for decoding the current video frame in the MV buffer 1265 as reference MVs for producing predicted MVs.

The in-loop filter 1245 performs filtering or smoothing operations on the decoded pixel data 1217 to reduce the artifacts of coding, particularly at boundaries of pixel blocks. In some embodiments, the filtering or smoothing operations performed by the in-loop filter 1245 include deblock filter (DBF), sample adaptive offset (SAO), and/or adaptive loop filter (ALF).

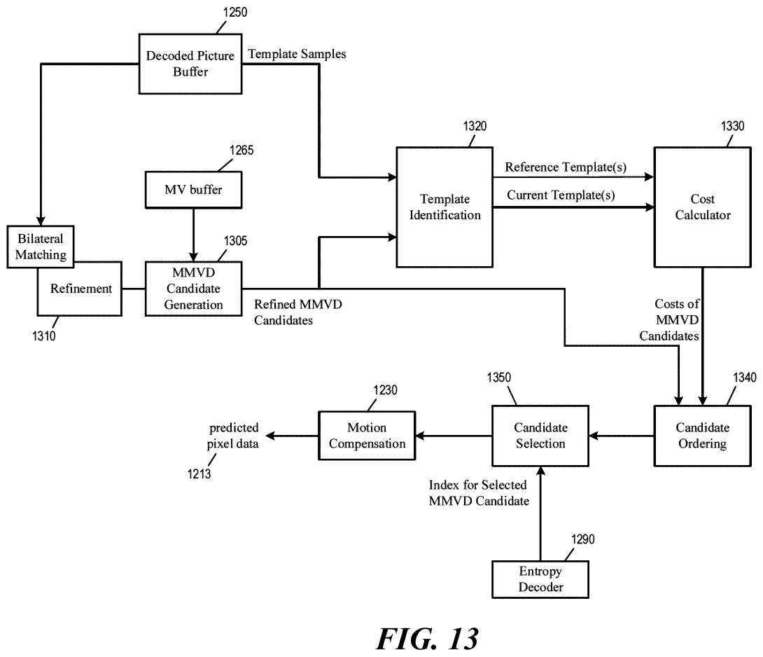

FIG. 13 illustrates portions of the video decoder 1200 that implement MMVD with refinement by bilateral matching and candidate reordering by template matching. As illustrated, a merge candidate is selected from the MV buffer 1265 by the entropy decoder 1290 and provided to a MMVD candidate generation module 1305, which generates MMVD candidates based on the selected merge candidate as the MMVD base motion (by adding different offsets at different directions). A refinement module 1310 refines the generated MMVD candidates by performing bilateral matching (using reference pictures stored in the decoded picture buffer 1250) and/or BDOF operations in one or more passes. The bilateral matching may be performed at CU-level and/or subblock-level in different refinement passes to refine the MMVD candidates.

For each (refined) MMVD candidate, a template identification module 1320 retrieves samples for a current template and a reference template from the decoded picture buffer 1250. The retrieved templates are provided to a cost calculator 1330, which performs template matching to produce a cost for each MMVD candidate. The computed costs of the various MMVD candidates are provided to a candidate ordering module 1340, which assigns indices to the various (refined) MMVD candidates according to their corresponding computed TM costs.

The entropy decoder module 1290 may receive a selection of a MMVD candidate from a syntax element in the bitstream 1295. The selection is provided to a candidate selection module 1350 to select one of the MMVD candidates from the candidate ordering module 1340. The motion compensation module 1230 performs motion compensation by using the selected MMVD candidate to generate a predictor for the current block as the predicted pixel data 1213.

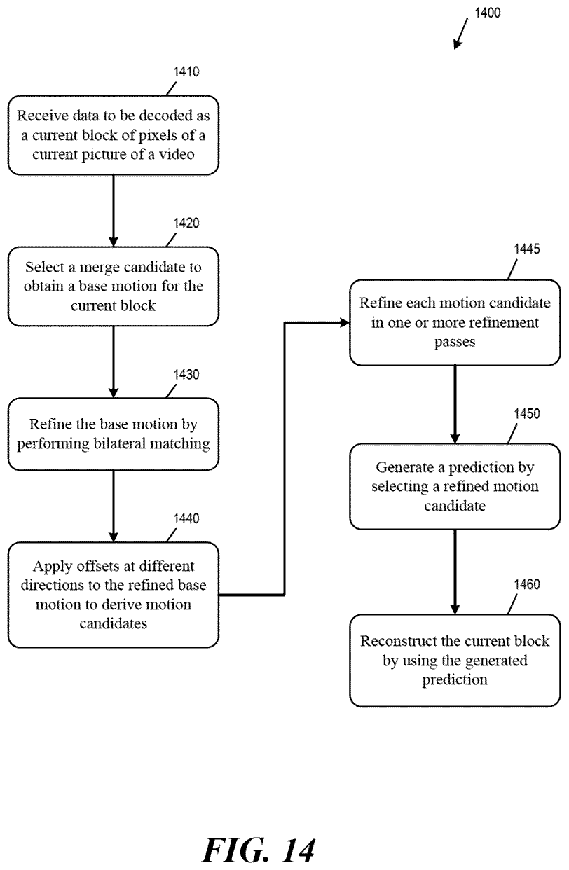

FIG. 14 conceptually illustrates a process 1400 for using refined MMVD candidates to decode a pixel block. In some embodiments, one or more processing units (e.g., a processor) of a computing device implementing the decoder 1200 performs the process 1400 by executing instructions stored in a computer readable medium. In some embodiments, an electronic apparatus implementing the decoder 1200 performs the process 1400.

The decoder receives (at block 1410) data to be decoded as a current block of pixels in a current picture of a video. The decoder selects (at block 1420) a merge candidate from a plurality of merge candidates to obtain a base motion for the current block. The decoder refines (at block 1430) the base motion by performing bilateral matching.

The decoder derives (at block 1440) motion candidates (e.g., MMVD candidates) from the refined base motion by e.g., applying offsets at different directions to the refined base motion. The different offsets and directions may be associated with MMVD indices. In some embodiments, a motion candidate or the base motion may include multiple subblock-level motion vectors for multiple subblocks of the current block.

The decoder refines (at block 1445) each motion candidate by one or more refinement passes, such as a first refinement pass for refining the motion candidate in a block level by bilateral matching, a second refinement pass for refining the motion candidate in a subblock level by bilateral matching, and a third refinement pass for refining the motion candidate by applying bi-directional optical flow (BDOF) to a result of the second refinement pass.

The decoder generates (at block 1450) a prediction of the current block by selecting a refined motion candidate. In some embodiments, the refined motion candidates are assigned indices for selection according to costs. A cost of a motion candidate may be determined based on a comparison between a current template of the current block and a reference template identified by the motion candidate, or determined based on a comparison between subblock templates of the current block and subblock templates identified by subblock motion vectors of the motion candidate. The decoder reconstructs (at block 1460) the current block by using the generated prediction. The decoder may then provide the reconstructed current block for display as part of the reconstructed current picture.

### XI. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

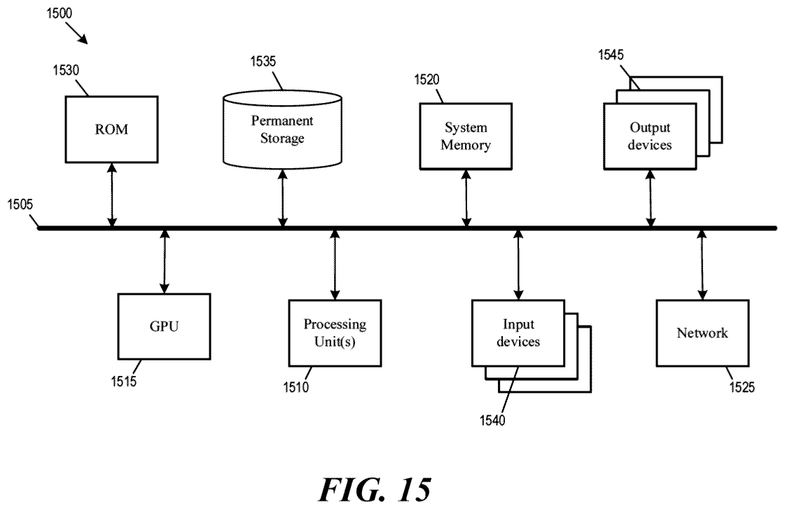

FIG. 15 conceptually illustrates an electronic system 1500 with which some embodiments of the present disclosure are implemented. The electronic system 1500 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1500 includes a bus 1505, processing unit(s) 1510, a graphics-processing unit (GPU) 1515, a system memory 1520, a network 1525, a read-only memory 1530, a permanent storage device 1535, input devices 1540, and output devices 1545.

The bus 1505 collectively represents all system, peripheral, and chipset buses that communicatively connect the numerous internal devices of the electronic system 1500. For instance, the bus 1505 communicatively connects the processing unit(s) 1510 with the GPU 1515, the read-only memory 1530, the system memory 1520, and the permanent storage device 1535.

From these various memory units, the processing unit(s) 1510 retrieves instructions to execute and data to process in order to execute the processes of the present disclosure. The processing unit(s) may be a single processor or a multi-core processor in different embodiments. Some instructions are passed to and executed by the GPU 1515. The GPU 1515 can offload various computations or complement the image processing provided by the processing unit(s) 1510.

The read-only-memory (ROM) 1530 stores static data and instructions that are used by the processing unit(s) 1510 and other modules of the electronic system. The permanent storage device 1535, on the other hand, is a read-and-write memory device. This device is a non-volatile memory unit that stores instructions and data even when the electronic system 1500 is off. Some embodiments of the present disclosure use a mass-storage device (such as a magnetic or optical disk and its corresponding disk drive) as the permanent storage device 1535.

Other embodiments use a removable storage device (such as a floppy disk, flash memory device, etc., and its corresponding disk drive) as the permanent storage device. Like the permanent storage device 1535, the system memory 1520 is a read-and-write memory device. However, unlike storage device 1535, the system memory 1520 is a volatile read-and-write memory, such a random access memory. The system memory 1520 stores some of the instructions and data that the processor uses at runtime. In some embodiments, processes in accordance with the present disclosure are stored in the system memory 1520, the permanent storage device 1535, and/or the read-only memory 1530. For example, the various memory units include instructions for processing multimedia clips in accordance with some embodiments. From these various memory units, the processing unit(s) 1510 retrieves instructions to execute and data to process in order to execute the processes of some embodiments.

The bus 1505 also connects to the input and output devices 1540 and 1545. The input devices 1540 enable the user to communicate information and select commands to the electronic system. The input devices 1540 include alphanumeric keyboards and pointing devices (also called “cursor control devices”), cameras (e.g., webcams), microphones or similar devices for receiving voice commands, etc. The output devices 1545 display images generated by the electronic system or otherwise output data. The output devices 1545 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 15, bus 1505 also couples electronic system 1500 to a network 1525 through a network adapter (not shown). In this manner, the computer can be a part of a network of computers (such as a local area network (“LAN”), a wide area network (“WAN”), or an Intranet, or a network of networks, such as the Internet. Any or all components of electronic system 1500 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 11 and FIG. 14) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving data to be encoded or decoded as a current block of pixels of a current picture of a video;
selecting a merge candidate from a plurality of merge candidates to obtain a base motion for the current block;
refining the base motion by performing bilateral matching;
derive motion candidates based on the refined base motion; and
encoding or decoding the current block by selecting a motion candidate to generate a prediction of the current block.

2. The video coding method of claim 1, wherein the motion candidates are derived by applying offsets at different directions to the refined base motion.

3. The video coding method of claim 1, further comprising refining the motion candidates by bilateral matching, wherein the prediction is generated based on the refined derived motion candidate.

4. The video coding method of claim 3, wherein refining a motion candidate comprises a first refinement pass for refining the derived motion candidate in a block level.

5. The video coding method of claim 4, wherein refining the motion candidate further comprises a second refinement pass for refining the derived motion candidate in a subblock level.

6. The video coding method of claim 5, wherein the motion candidate comprises a plurality of subblock-level motion vectors for a plurality of subblocks of the current block.

7. The video coding method of claim 5, wherein refining the motion candidate further comprises a third refinement pass for refining the derived motion candidate by applying bi-directional optical flow (BDOF) to a result of the second refinement pass.

8. The video coding method of claim 3, wherein refining a motion candidate comprises a refinement pass for refining the derived motion candidate by applying bi-directional optical flow (BDOF).

9. The video coding method of claim 3, wherein a motion candidate comprises a plurality of subblock-level motion vectors for a plurality of subblocks of the current block.

10. The video coding method of claim 1, wherein the motion candidates are assigned indices according to costs.

11. The video coding method of claim 10, wherein a cost of a motion candidate is determined based on a comparison between a current template of the current block and a reference template identified by the motion candidate.

12. The video coding method of claim 10, wherein a cost of a motion candidate is determined based on a comparison between subblock templates of the current block and subblock templates identified by subblock motion vectors of the motion candidate.

13. An electronic apparatus comprising:
a video coder circuit configured to perform operations comprising:
receiving data to be encoded or decoded as a current block of pixels of a current picture of a video;
selecting a merge candidate from a plurality of merge candidates to obtain a base motion for the current block;
refining the base motion by performing bilateral matching;
derive motion candidates based on the refined base motion; and
encoding or decoding the current block by selecting a motion candidate to generate a prediction of the current block.

14. A video decoding method comprising:
receiving data to be decoded as a current block of pixels of a current picture of a video;
selecting a merge candidate from a plurality of merge candidates to obtain a base motion for the current block;
refining the base motion by performing bilateral matching;
derive motion candidates based on the refined base motion; and
reconstructing the current block by selecting a motion candidate to generate a prediction of the current block.

15. A video encoding method comprising:
receiving data to be encoded as a current block of pixels of a current picture of a video;
selecting a merge candidate from a plurality of merge candidates to obtain a base motion for the current block;
refining the base motion by performing bilateral matching;
derive motion candidates based on the refined base motion; and
encoding the current block by selecting a motion candidate to generate a prediction of the current block.
